(19) United States
(12) Patent Application Publication
(10) Pub. No.: US 2013/0108187 A1
(43) Pub. Date: May 2, 2013

(54) IMAGE WARPING METHOD AND COMPUTER PROGRAM PRODUCT THEREOF

(71) Applicants: Augustine Tsai, Taipei City (TW); Meng-Hsuan Chia, Taipei City (TW); Wen-Kai Liu, Taipei City (TW)

(72) Inventors: Augustine Tsai, Taipei City (TW); Meng-Hsuan Chia, Taipei City (TW); Wen-Kai Liu, Taipei City (TW)

(21) Appl. No.: 13/347,997

(22) Filed: Jan. 11, 2012

(30) Foreign Application Priority Data
Nov. 1, 2011 (TW) 100139686

(51) Int. Cl. G06K 9/32

(52) U.S. Cl. 382/295

(57) ABSTRACT

An image warping method and a computer program product thereof are provided. The image warping method comprises the following steps: defining a plurality of original feature points of an original image, wherein the original image corresponds to an original view angle; calculating a plurality of original pixel coordinates of the original feature points in the original image; defining a plurality of new feature points of the original image, wherein the new feature points respectively correspond to the original feature points; calculating a plurality of new pixel coordinates of the new feature points projected onto the original image; and approaching each of the original pixel coordinates of the original feature points to each of the new pixel coordinates of the corresponding new feature points in the original image so that the original image is warped into a new image, wherein the new image corresponds to a new view angle.

This application claims priority to Taiwan Patent Application No. 100139686 filed on Nov. 1, 2011, which is hereby incorporated by reference in its entirety.

### CROSS-REFERENCES TO RELATED APPLICATIONS

Not applicable.

### BACKGROUND OF THE INVENTION

1. Field of the Invention

The present invention relates to an image warping method and a computer program product thereof; and more particularly, the present invention relates to an image warping method and a computer program product thereof that approach a plurality of original feature points of an original image to a plurality of corresponding new feature points so that the original image is warped into a new image.

2. Descriptions of the Related Art

For modern people's demands of stereoscopic images, topics related to the stereoscopic images have attracted much attention. In order to satisfy these demands, technologies related to stereoscopic images are increasing sophistically. In recent years, the stereoscopic image displays such as three-dimensional televisions (3DTVs) gradually become popular in the market, and people can enjoy the visual experiences brought by the stereoscopic images. However, stereoscopic image acquiring devices are not as popular as the stereoscopic image displaying devices because of technical issues. Therefore, stereoscopic image acquiring technologies do not develop as rapidly as the stereoscopic image displaying devices, and this has impeded popularization of the three-dimensional multimedia devices.

One of the primary issues that impede the popularization of stereoscopic image acquiring devices is that technologies for transforming two-dimensional (2D) images into 3D images are not sophisticated. Accordingly, how to effectively transform 2D images into 3D images has become an important topic in the art. In the present time, a technical means commonly used for transforming 2D images into 3D images is the depth-image-based rendering (DIBR) method. According to the DIBR method, image depth information known in advance is used to obtain the depth of each pixel corresponding to an original 2D image, and a displacement between a new view angle and an original view angle is calculated according to pixel depth differences between the pixels to generate an image with a different view angle. By combining images of different view angles into a multi-view-angle image, the 2D image is transformed into a 3D image.

Unfortunately, it is difficult to obtain the image depth information on which the DIBR method relies. Generally, the image depth information may be obtained through manual process or computer visual technologies. However, the manual process needs a lot of labors and time, and the computer visual technologies also need much time in calculation. Besides, it is almost impossible to estimate the image depth information accurately because of noises no matter of manual process or a computer visual technology. On the other hand, the sheltering phenomenon existing between objects in an image will generate voids in the image having a new view angle after being displaced. After all, the most prominent drawback of the DIBR method is that adjacent pixels must be used to fill such voids, which tends to cause a virtual edge.

According to the above descriptions, since most of 2D images are transformed into 3D images by the DIBR method and this method is limited by the accuracy of image depth information, a bottleneck exists for development of the stereoscopic image acquiring technologies. Accordingly, efforts still have to be made in the art to overcome the drawbacks of the conventional technologies for transforming 2D images into 3D images so as to promote popularization of stereoscopic image displays.

### SUMMARY OF THE INVENTION

An objective of the present invention is to provide an image warping method and a computer program product thereof. In detail, the image warping method and the computer program product thereof according to the present invention warp an original image into a new image corresponding to a new view angle by approaching a plurality of original feature points of the original image to a plurality of corresponding new feature points. Because the image warping method and the computer program product thereof according to the present invention can accurately generate an image corresponding to a new view angle without the need of image depth information, a 2D image can be transformed into a 3D image without using the conventional DIBR method. In other words, the image warping method and the computer program product thereof according to the present invention can promote popularization of stereoscopic image displays by effectively overcoming the drawbacks of using the DIBR method to transform a 2D image into a 3D image.

To achieve the aforesaid objective, the present invention provides an image warping method for use in a device having an image processing function. The device comprises a processor. The image warping method comprises the following steps:

(a) defining a plurality of original feature points of an original image by the processor, wherein the original image corresponds to an original view;

(b) calculating a plurality of original pixel coordinates of the original feature points in the original image by the processor;

(c) defining a plurality of new feature points of the original image by the processor, wherein the new feature points respectively correspond to the original feature points of the original image;

(d) calculating a plurality of new pixel coordinates of the new feature points projected onto the original image by the processor; and

(e) approaching each of the original pixel coordinates of the original feature points of the original image to each of the new pixel coordinates of the corresponding new feature points by the processor, so that the original image is warped into a new image, wherein the new image corresponds to a new view.

To achieve the aforesaid objective, the present invention further provides a computer program product. The computer program product stores a program for executing an image warping method, and when being loaded into a computer device, the program executes:

a code A, for defining a plurality of original feature points of an original image, wherein the original image corresponds to an original view;

a code B, for calculating a plurality of original pixel coordinates of the original feature points in the original image;

a code C, for defining a plurality of new feature points of the original image, wherein the new feature points respectively correspond to the original feature points of the original image;

a code D, for calculating a plurality of new pixel coordinates of the new feature points projected onto the original image; and

a code E, for approaching each of the original pixel coordinates of the original feature points of the original image to each of the new pixel coordinates of the corresponding new feature points, so that the original image is warped into a new image, wherein the new image corresponds to a new view.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a flowchart diagram of a first embodiment of the present invention;

FIG. 2 is a detailed flowchart diagram of a step S9 of the first embodiment according to the present invention;

FIG. 3 is a schematic view illustrating warping of a grid image according to the present invention; and

FIG. 4 is a detailed flowchart diagram of a step S5 of the first embodiment according to the present invention.

### DESCRIPTION OF THE PREFERRED EMBODIMENT

In the following descriptions, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

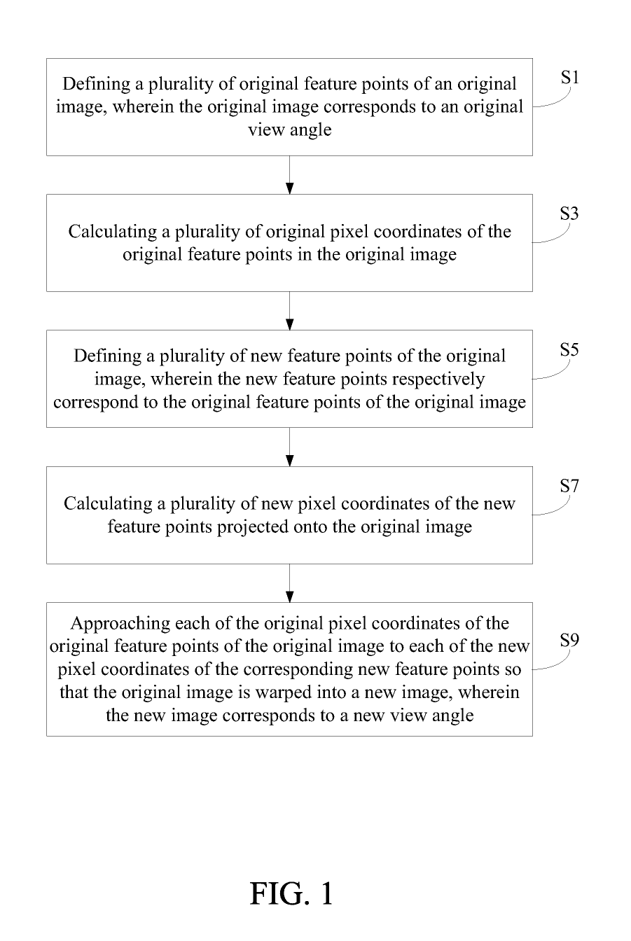

A first embodiment of the present invention is an image warping method. The image warping method of the first embodiment will be described with reference to FIG. 1, which is a flowchart diagram of the first embodiment. In this embodiment, the image warping method is for use in a device having an image processing function. The device at least comprises a processor configured to execute steps of the image warping method. It shall be appreciated that, for purpose of simplicity, other elements (e.g., a memory, an image output/input device and so on) of the device having an image processing function will be omitted from description in the present embodiment. On the other hand, the device having an image processing function may be a camera, a personal computer (PC), a mobile phone, a notebook computer or some other device having an image processing function.

The process procedure of this embodiment will be detailed hereinafter. As shown in FIG. 1, a plurality of original feature points of an original image are defined by the processor in step S1. The original image corresponds to an original view. In step S3, a plurality of original pixel coordinates of the original feature points in the original image are calculated by the processor. Specifically, the original image in this embodiment is a 2D image viewed at a certain view angle. For example, a direction in which a photographer faces an object when taking an image of the object is just the original view angle set forth in this embodiment, and the image obtained is just the original image set forth in this embodiment. Besides, the original image in this embodiment may be in the form of either a physical image (e.g., a photo or a picture) or image data (e.g., image data consisting of a plurality of bits), both of which fall within the scope of the present invention.

In this embodiment, the original feature points are used to represent primary features of the original image, and how these original feature points are defined may be readily appreciated by those of ordinary skill in the art and, thus, will not be further described herein. On the other hand, the purpose of the step S3 is to define positions of the original feature points in the original image by means of pixel coordinates.

A plurality of new feature points of the original image are defined by the processor in step S5. The new feature points respectively correspond to the original feature points of the original image. Then, a plurality of new pixel coordinates of the new feature points projected onto the original image are calculated by the processor in step S7. In this embodiment, the new feature points are equivalent to feature points defined when the original image is observed at a new view angle different from the original view angle, and image features represented by the new feature points are identical to those represented by the original feature points. For example, if the original image is a pencil and the original feature points are used to represent a tip of the pencil viewed at the original view angle, then the new feature points represent the tip of the pencil at a new view angle. In other words, by “the new feature points respectively correspond to the original feature points of the original image,” it means that the same image features are viewed at different view angles.

The purpose of the step S7 is to define positions of the new feature points in the original image by means of pixel coordinates. In detail, although the image features represented by the new feature points are the same as those represented by the original feature points, the new feature points are defined by viewing the original image at a new view angle different from the original view angle; therefore, the new pixel coordinate of each of the new feature points projected onto the original image has a difference from the corresponding original pixel coordinate due to the different viewing angles.

Each of the original pixel coordinates of the original feature points of the original image is approached to each of the new pixel coordinates of the corresponding new feature points by the processor in step S9 so that the original image is warped into a new image. The new image corresponds to a new view angle. Specifically, the purpose of the step S9 is to warp the original image into a new image by reducing a distance between each of the original feature points and the corresponding new feature point so that the new image is equivalent to an image obtained by viewing the feature points at the new view angle.

The image warping method described in this embodiment may be implemented by a computer program product. When the computer program product is loaded into a computer, a plurality of codes comprised in the computer program product will be executed by the computer to accomplish the image warping method of this embodiment. The computer program product may be embodied in a tangible computer readable medium, such as a read only memory (ROM), a flash memory, a floppy disk, a hard disk, a compact disk (CD), a mobile disk, a magnetic tape, a database accessible to networks or any other storage media with the same function and well known to those skilled in the art.

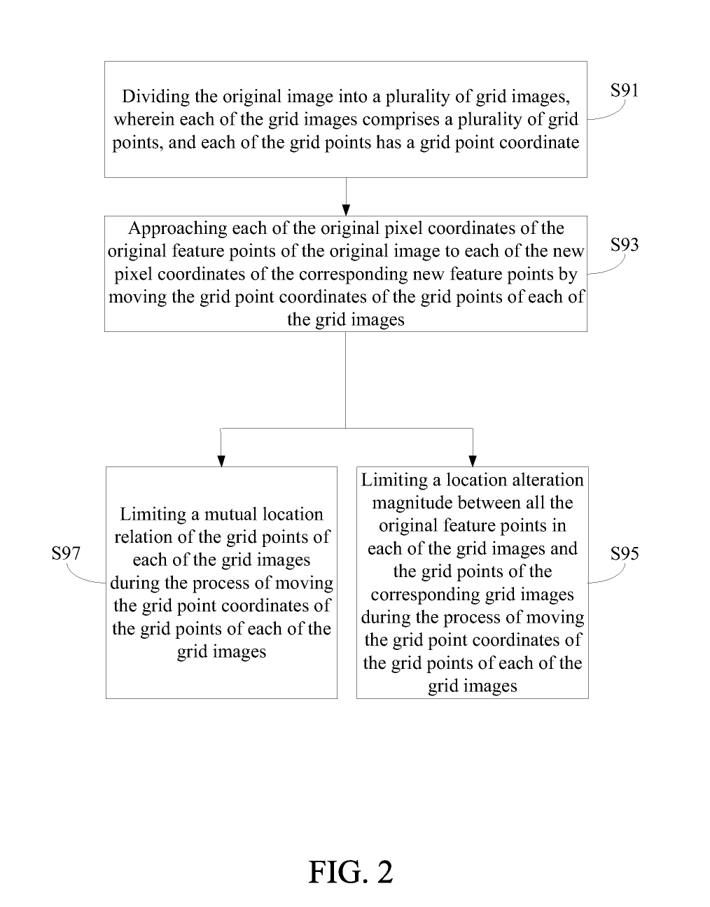

A second embodiment of the present invention is also an image warping method. The image warping method of the second embodiment will be described with reference to FIG. 1 and FIG. 2 together. FIG. 2 is a detailed flowchart diagram of the step S9. Steps of the image warping method of this embodiment that are not particularly noted or that bear the same reference numerals as steps of the first embodiment are all the same as those of the first embodiment, so no further description will be made thereon herein.

The second embodiment differs from the first embodiment in that, the step S9 further comprises steps shown in FIG. 2. As shown in FIG. 2, the original image is divided into a plurality of grid images by the processor in step S91. Each of the grid images comprises a plurality of grid points, and each of the grid points has a grid point coordinate. Specifically, the grip point coordinate of each of the grid points represents a pixel coordinate corresponding to a pixel position of the grip point in the original image.

The grid images of this embodiment may be of various forms, for example, a square form, a triangular form, a hexagonal form, an octagonal form, a polygonal form or the like. Besides, the grid images of different forms may comprise different numbers of grid points; for example, a grid image of a triangular form has three grip points, a grid image of a hexagonal form has six grip points, a grid image of an octagonal form has eight grip points, and so on. However, for purpose of convenience, grid images of the square form will be taken as an example in the following descriptions. Correspondingly, the original image is divided into a plurality of square images by the processor in this embodiment. The four vertices of each of the square images represent grip points, and the grid point coordinate of each of the grid points corresponds to a pixel coordinate in the original image.

As shown in FIG. 2, each of the original pixel coordinates of the feature points of the original image is approached to each of the new pixel coordinates of the corresponding new feature points by moving the grid point coordinates of the grid points of each of the grid images by the processor in step S93. Specifically, the purpose of the step S93 is to warp the square images of the original image so that the warped image corresponds to a new view angle.

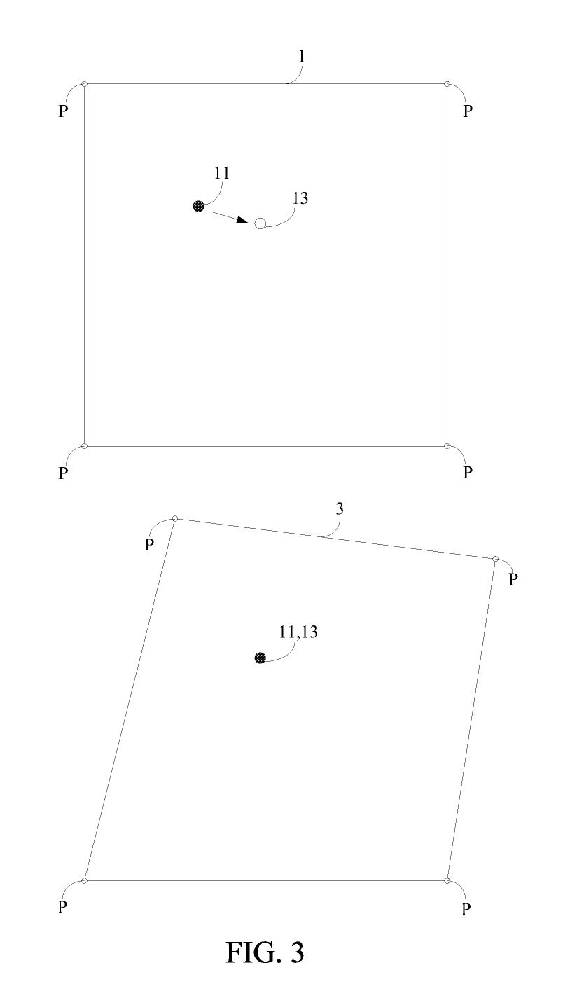

To further describe the process of warping the image, please refer next to FIG. 3. FIG. 3 is a schematic view illustrating warping of a square image. As shown in FIG. 3, one original square image 1 comprises four grid points P, and comprises an original feature point 11 and a new feature point 13 therein. By moving the grid point coordinates of the four grid points P in such a way that the original grid image 1 is warped/dragged while the original pixel coordinate of the original feature point 11 approaches to the new pixel coordinate of the new feature point 13, a new grid image 3 is generated. Although the process of warping a square image shown in FIG. 3 only illustrates a process of warping a square image obtained by dividing the original image and the square image has only one feature point therein, implementations in which the square image comprises a plurality of feature points and the process of warping the original image comprising a plurality of such square images into a new image will be readily appreciated by those of ordinary skill in the art from FIG. 3 and, thus, will not be further described herein.

The steps S95 and S97 of this embodiment are executed in combination with the step S93. In step S95, a location alteration magnitude between all the original feature points in each of the grid images and the grid points of the corresponding grid images is limited by the processor during the process of moving the grid point coordinates of the grid points of each of the grid images. On the other hand, a mutual location relation of the grid points of each of the grid images is limited by the processor during the process of moving the grid point coordinates of the grid points of each of the grid images in step S97. In the steps S95 and S97, the grid point coordinates of the grid points of each of the grid images may be moved further according to a pixel brightness variance of each of the corresponding grid images, but this is not intended to limit the present invention.

Besides, the steps S95 and S97 of this embodiment may be implemented by a content-preserving warping method, but the present invention is not limited thereto. Further speaking, the content-preserving warping method complies with two concepts, namely, the data term and the smooth term, and requires that a balance point is obtained between the data term and the smooth term. The data term and the smooth term may correspond to the step S95 and the step S97 respectively.

The data term is used to limit grip point coordinates of grid points of a square image so that a location of a feature point in the square image to which it belongs will not change too much after the square image is warped. On the other hand, the smooth term is used to limit that a mutual location relation between grid points of a square image will not change too much after the square image is warped so as to avoid excessive twisting of the square image. Therefore, the square image can be warped under the conditions of content preserving by adjusting the data term and the smooth term. It shall be appreciated that, the pixel brightness variance of each square image may be used as a weight value for the data term and the smooth term, in which case a smaller pixel brightness variance represents a higher possibility that there is a high warping extent; however, the pixel brightness variances is not intended to limit the present invention.

In addition to the aforesaid steps, the second embodiment can also execute all the steps set forth in the first embodiment. How the second embodiment executes these steps of the first embodiment will be readily appreciated by those of ordinary skill in the art based on the explanation of the first embodiment, and thus will not be further described herein. Besides, the image warping method described in this embodiment may also be implemented by a computer program product. When the computer program product is loaded into a computer, a plurality of codes comprised in the computer program product will be executed by the computer to accomplish the image warping method of this embodiment. The computer program product may be embodied in a tangible computer readable medium, such as a read only memory (ROM), a flash memory, a floppy disk, a hard disk, a compact disk (CD), a mobile disk, a magnetic tape, a database accessible to networks or any other storage media with the same function and well known to those skilled in the art.

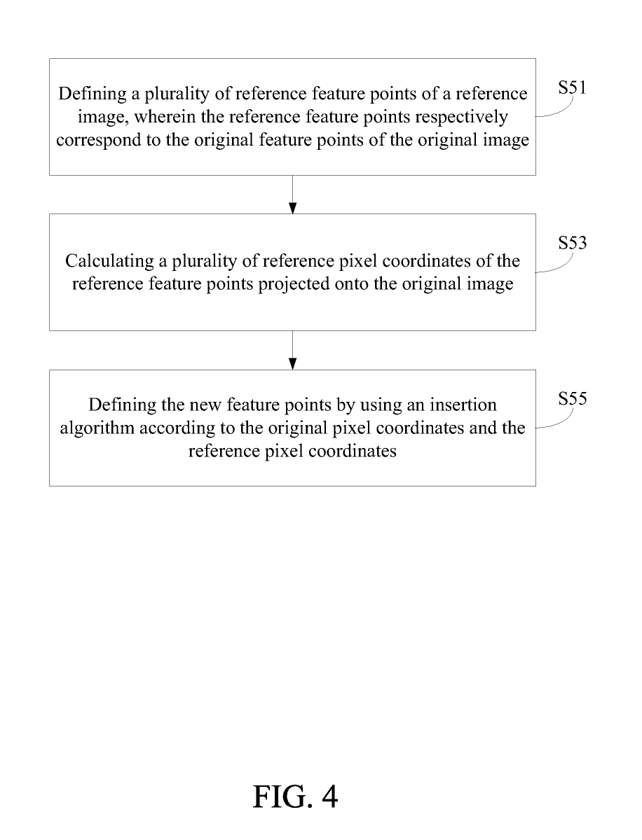

A third embodiment of the present invention is also an image warping method. The image warping method of the third embodiment will be described with reference to FIG. 1 and FIG. 4 together. FIG. 4 is a detailed flowchart diagram of the step S5. It shall be appreciated that, steps of the image warping method of this embodiment that are not particularly noted or that bear the same reference numerals as steps of the first embodiment are all the same as those of the first embodiment, so no further description will be made thereon herein.

The third embodiment differs from the first embodiment in that, the step S5 further comprises steps shown in FIG. 4. In detail, a plurality of reference feature points of a reference image is defined by the processor in step S51. The reference feature points respectively correspond to the original feature points of the original image. Further speaking, the reference image described in this embodiment is an image obtained by viewing the original image at another view angle. For example, a direction in which a photographer faces an object when taking an image of the object is just the original view angle set forth in this embodiment, and the image obtained is just the original image set forth in this embodiment. In this case, if the photographer moves horizontally by a unit distance, then the direction in which the photographer faces the object at this time is just the another view angle of this embodiment and the image obtained is just the reference image set forth in this embodiment. Besides, similar to what described in the first embodiment, by “the reference feature points respectively correspond to the original feature points of the original image,” it means that the image features represented by the reference feature points are the same as the image features represented by the original feature points.

Furthermore, a plurality of reference pixel coordinates of the reference feature points projected onto the original image are calculated by the processor in step S53, and the new feature points are defined by the processor using an insertion algorithm according to the original pixel coordinates and the reference pixel coordinates. Specifically, the purpose of the step S53 is to define locations of the reference feature points in the original image by use of pixel coordinates, and the purpose of the step S55 is to define the new feature points described in the step S5 by using the insertion algorithm.

It shall be appreciated that, the insertion algorithm used in this embodiment is one of an interpolation algorithm and an extrapolation algorithm, and in this embodiment, the new feature points described in the step S5 are defined by using the insertion algorithm according to the original pixel coordinates and the reference pixel coordinates. In other words, this embodiment only needs to calculate feature points for representing the same image features in at least two images (e.g., an original image and a reference image), and then a plurality of new feature points when viewing the original image at different view angles can be calculated by using the insertion algorithm.

In addition to the aforesaid steps, the third embodiment can also execute all the steps set forth in the first embodiment. How the third embodiment executes these steps of the first embodiment will be readily appreciated by those of ordinary skill in the art based on the explanation of the first embodiment, and thus will not be further described herein. Besides, the image warping method described in this embodiment may also be implemented by a computer program product. When the computer program product is loaded into a computer, a plurality of codes comprised in the computer program product will be executed by the computer to accomplish the image warping method of this embodiment. The computer program product may be embodied in a tangible computer readable medium, such as a read only memory (ROM), a flash memory, a floppy disk, a hard disk, a compact disk (CD), a mobile disk, a magnetic tape, a database accessible to networks or any other storage media with the same function and well known to those skilled in the art.

A fourth embodiment of the present invention is also an image warping method. The image warping method of the fourth embodiment will be described with reference to FIG. 1 to FIG. 4 together. Specifically, this embodiment differs from the aforesaid embodiments in that, the step S9 further comprises the steps shown in FIG. 2 and the step S5 further comprises the steps shown in FIG. 4. In other words, the image warping method of this embodiment comprises the steps of FIG. 1 and FIGS. 3˜4 simultaneously. Accordingly, this embodiment can also execute all the steps set forth in the aforesaid embodiments. How the fourth embodiment executes these steps will be readily appreciated by those of ordinary skill in the art based on the explanation of the first to the third embodiments, and thus will not be further described herein.

The image warping method described in this embodiment may also be implemented by a computer program product. When the computer program product is loaded into a computer, a plurality of codes comprised in the computer program product will be executed by the computer to accomplish the image warping method of this embodiment. The computer program product may be embodied in a tangible computer readable medium, such as a read only memory (ROM), a flash memory, a floppy disk, a hard disk, a compact disk (CD), a mobile disk, a magnetic tape, a database accessible to networks or any other storage media with the same function and well known to those skilled in the art.

According to the above descriptions, the image warping method and the computer program product thereof according to the present invention warp an original image into a new image corresponding to a new view angle by approaching a plurality of original feature points of the original image to a plurality of corresponding new feature points. Because the image warping method and the computer program product thereof according to the present invention can accurately generate an image corresponding to a new view angle without the need of image depth information, a 2D image can be transformed into a 3D image without using the conventional DIBR method. In other words, the image warping method and the computer program product thereof according to the present invention can promote popularization of stereoscopic image displays by effectively overcoming the drawbacks of using the DIBR method to transform a 2D image into a 3D image.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An image warping method for use in a device having an image processing function, the device comprising a processor, the image warping method comprising the following steps:
(a) defining a plurality of original feature points of an original image by the processor, wherein the original image corresponds to an original view angle;
(b) calculating a plurality of original pixel coordinates of the original feature points in the original image by the processor;
(c) defining a plurality of new feature points of the original image by the processor, wherein the new feature points respectively correspond to the original feature points of the original image;
(d) calculating a plurality of new pixel coordinates of the new feature points projected onto the original image by the processor; and
(e) approaching each of the original pixel coordinates of the original feature points of the original image to each of the new pixel coordinates of the corresponding new feature points by the processor, so that the original image is warped into a new image, wherein the new image corresponds to a new view angle.

2. The image warping method as claimed in claim 1, wherein the step (e) further comprises the following steps:
(e1) dividing the original image into a plurality of grid images by the processor, wherein each of the grid images comprises a plurality of grid points, and each of the grid points has a grid point coordinate;
(e2) approaching each of the original pixel coordinates of the original feature points of the original image to each of the new pixel coordinates of the corresponding new feature points by moving the grid point coordinates of the grid points of each of the grid images by the processor;
(e3) limiting a location alteration magnitude between all the original feature points in each of the grid images and the grid points of the corresponding grid images by the processor during moving the grid point coordinates of the grid points of each of the grid images; and
(e4) limiting a mutual location relation of the grid points of each of the grid images by the processor during moving the grid point coordinates of the grid points of each of the grid images.

3. The image warping method as claimed in claim 2, wherein the grid point coordinates of the grid points of each of the grid images are moved according to a pixel brightness variance of each of the corresponding grid images.

4. The image warping method as claimed in claim 1, wherein the step (c) further comprises the following steps:
(c1) defining a plurality of reference feature points of a reference image by the processor, wherein the reference feature points respectively correspond to the original feature points of the original image;
(c2) calculating a plurality of reference pixel coordinates of the reference feature points projected onto the original image by the processor; and
(c3) defining the new feature points by using an insertion algorithm by the processor according to the original pixel coordinates and the reference pixel coordinates.

5. The image warping method as claimed in claim 4, wherein the insertion algorithm is one of an interpolation algorithm and an extrapolation algorithm.

6. The image warping method as claimed in claim 2, wherein the step (c) further comprises the following steps:
(c1) defining a plurality of reference feature points of a reference image by the processor, wherein the reference feature points respectively correspond to the original feature points of the original image;
(c2) calculating a plurality of reference pixel coordinates of the reference feature points projected onto the original image by the processor; and
(c3) defining the new feature points by using an insertion algorithm by the processor according to the original pixel coordinates and the reference pixel coordinates.

7. The image warping method as claimed in claim 6, wherein the insertion algorithm is one of an interpolation algorithm and an extrapolation algorithm.

8. The image warping method as claimed in claim 3, wherein the step (c) further comprises the following steps:
(c1) defining a plurality of reference feature points of a reference image by the processor, wherein the reference feature points respectively correspond to the original feature points of the original image;
(c2) calculating a plurality of reference pixel coordinates of the reference feature points projected onto the original image by the processor; and
(c3) defining the new feature points by using an insertion algorithm by the processor according to the original pixel coordinates and the reference pixel coordinates.

9. The image warping method as claimed in claim 8, wherein the insertion algorithm is one of an interpolation algorithm and an extrapolation algorithm.

10. A computer program product, storing a program for executing an image warping method, the program being loaded into a computer device to execute:
a code A, for defining a plurality of original feature points of an original image, wherein the original image corresponds to an original view angle;
a code B, for calculating a plurality of original pixel coordinates of the original feature points in the original image;
a code C, for defining a plurality of new feature points of the original image, wherein the new feature points respectively correspond to the original feature points of the original image;
a code D, for calculating a plurality of new pixel coordinates of the new feature points projected onto the original image; and
a code E, for approaching each of the original pixel coordinates of the original feature points of the original image to each of the new pixel coordinates of the corresponding new feature points, so that the original image is warped into a new image, wherein the new image corresponds to a new view angle.

11. The computer program product as claimed in claim 10, wherein the code E further comprises:
a code E1, for dividing the original image into a plurality of grid images, wherein each of the grid images comprises a plurality of grid points, and each of the grid points has a grid point coordinate;
a code E2, for approaching each of the original pixel coordinates of the original feature points of the original image to each of the new pixel coordinates of the corresponding new feature points by moving the grid point coordinates of the grid points of each of the grid images;
a code E3, for limiting a location alteration magnitude between all the original feature points in each of the grid images and the grid points of the corresponding grid images during moving the grid point coordinates of the grid points of each of the grid images; and
a code E4, for limiting a mutual location relation of the grid points of each of the grid images during moving the grid point coordinates of the grid points of each of the grid images.

12. The computer program product as claimed in claim 11, wherein the grid point coordinates of the grid points of each of the grid images are moved according to a pixel brightness variance of each of the corresponding grid images.

13. The computer program product as claimed in claim 10, wherein the code C further comprises:
a code C1, for defining a plurality of reference feature points of a reference image, wherein the reference feature points respectively correspond to the original feature points of the original image;
a code C2, for calculating a plurality of pixel coordinates of the reference feature points projected onto the original image; and
a code C3, for defining the new feature points by using an insertion algorithm according to the original pixel coordinates and the reference pixel coordinates.

14. The computer program product as claimed in claim 13, wherein the insertion algorithm is one of an interpolation algorithm and an extrapolation.

15. The computer program product as claimed in claim 11, wherein the code C further comprises:
a code C1, for defining a plurality of reference feature points of a reference image, wherein the reference feature points respectively correspond to the original feature points of the original image;
a code C2, for calculating a plurality of pixel coordinates of the reference feature points projected onto the original image; and
a code C3, for defining the new feature points by using an insertion algorithm according to the original pixel coordinates and the reference pixel coordinates.

16. The computer program product as claimed in claim 15, wherein the insertion algorithm is one of an interpolation algorithm and an extrapolation.

17. The computer program product as claimed in claim 12, wherein the code C further comprises:
a code C1, for defining a plurality of reference feature points of a reference image, wherein the reference feature points respectively correspond to the original feature points of the original image;
a code C2, for calculating a plurality of pixel coordinates of the reference feature points projected onto the original image; and
a code C3, for defining the new feature points by using an insertion algorithm according to the original pixel coordinates and the reference pixel coordinates.

18. The computer program product as claimed in claim 17, wherein the insertion algorithm is one of an interpolation algorithm and an extrapolation.
